(19) United States
(12) Patent Application Publication
(10) Pub. No.: US 2026/0005808 A1
(43) Pub. Date: Jan. 1, 2026

(54) WIDE CHANNEL OCCUPANCY DETERMINATION ENHANCEMENT IN WI-FI NETWORKS

(71) Applicant: GM Global Technology Operations LLC, Detroit, MI (US)

(72) Inventor: Azin Neishaboori, Plymouth, MI (US)

(21) Appl. No.: 18/756,076

(22) Filed: Jun. 27, 2024

(51) Int. Cl. H04L 5/00; H04W 72/56

(52) U.S. Cl. CPC H04L 5/0046; H04L 5/0064; H04L 5/0073; H04L 5/0094; H04W 72/56

(57) ABSTRACT

A vehicle includes a Wi-Fi system for transmitting a signal. The Wi-Fi system includes a channel having a primary subchannel and one or more secondary subchannels. A sensor measures energies of signals in the primary subchannel and in each of the one or more secondary subchannels. A processor determines that the primary subchannel is idle when the energy in the primary subchannel is less than a primary subchannel energy threshold, assigns a score to each of the one or more secondary subchannels based on the secondary subchannel energy, calculates a sum of the scores, and transmits the signal over the channel when the sum of the scores is less than a score threshold.

The subject disclosure relates to communication networks in vehicles and, in particular, to a system and method for controlling wireless fidelity (WiFi) systems integrated into a vehicle.

A vehicle can have a wireless fidelity (WiFi) communication system for various communication needs, such as by providing Internet, phone capabilities, wireless cameras, etc. to passengers. A WiFi channel has many sub-channels which can be selected by a communication device. Each sub-channel can have different levels of use or occupation, limiting its availability for transmission of a selected signal. Accordingly, it is desirable to provide a method for managing WiFi communications based on how busy or occupied the channel is.

### SUMMARY

In one exemplary embodiment, a method of transmitting a signal in a wireless fidelity (WiFi) system is disclosed. A primary subchannel of a channel of the WiFi system is determined to be idle when an energy in the primary subchannel is less than a primary subchannel energy threshold, the channel including the primary subchannel and one or more secondary subchannels. A subchannel energy through each of the one or more secondary subchannels is measured. A score is assigned to each of the one or more secondary subchannels based on the subchannel energy. A sum of the scores is calculated. The signal is transmitted over the channel when the sum of the scores is less than a score threshold.

In addition to one or more of the features described herein, the method further includes assigning the score for a selected secondary subchannel based on an energy interval in which the energy of the secondary subchannel is located.

In addition to one or more of the features described herein, the method further includes determining the channel to be idle when the energy of each of the one or more secondary subchannels is less than a secondary subchannel threshold.

In addition to one or more of the features described herein, the method further includes transmitting the signal with a selected probability, wherein the selected probability is a function of at least one of an access category, an age of a packet, and an urgency of the packet.

In addition to one or more of the features described herein, the method further includes lowering the score threshold when at least one of a physical layer protocol data unit (PPDU) is part of a high data rate frame and the PPDUs part of low latency flow.

In addition to one or more of the features described herein, the method further includes assigning a maximum score to the secondary subchannel when the energy in the secondary subchannel is from a Wi-Fi packet belonging to an Overlapping Basic Service Sets PPDU transmission.

In addition to one or more of the features described herein, a history of transmission over the subchannel indicates a periodic stream and the score for the subchannel is determined at least in part based on a duty cycle of the periodic stream.

In another exemplary embodiment, a wireless fidelity (WiFi) system is disclosed. The WiFi system includes a channel including a primary subchannel and one or more secondary subchannels, a sensor for measuring an energy of signals in the primary subchannel and in each of the one or more secondary subchannels, and a processor. The processor s configured to determine that the primary subchannel is idle based when the energy in the primary subchannel is less than a primary subchannel energy threshold, assign a score to each of the one or more secondary subchannels based on the subchannel energy, calculate a sum of the scores, and transmit a signal over the channel when the sum of the scores is less than a score threshold.

In addition to one or more of the features described herein, the processor is further configured to assign the score for a selected secondary subchannel based on an energy interval in which the energy of the secondary subchannel is located.

In addition to one or more of the features described herein, the processor is further configured to determine the channel to be idle when the energy of each of the one or more secondary subchannels is less than a secondary subchannel threshold.

In addition to one or more of the features described herein, the processor is further configured to transmit the signal with a selected probability, wherein the selected probability is a function of at least one of an access category, an age of a packet, and an urgency of the packet.

In addition to one or more of the features described herein, the processor is further configured to lower the score threshold when at least one of a physical layer protocol data unit (PPDU) is part of a high data rate frame and the PPDUs part of low latency flow.

In addition to one or more of the features described herein, the processor is further configured to assign a maximum score to the secondary subchannel when the energy in the secondary subchannel is from a Wi-Fi packet belonging to an Overlapping Basic Service Sets PPDU transmission.

In addition to one or more of the features described herein, a history of transmission over the subchannel indicates a periodic stream and the score for the subchannel is determined at least in part based on a duty cycle of the periodic stream.

In yet another exemplary embodiment, a vehicle is disclosed. The vehicle includes a wireless fidelity (WiFi) system configured to communication over a channel including a primary subchannel and one or more secondary subchannels, a sensor of the WiFi system configured to measure an energy of signals in the primary subchannel and in each of the one or more secondary subchannels, and a processor of the WiFi system. The processor is configured to determine that the primary subchannel is idle when the energy in the primary subchannel is less than a primary subchannel energy threshold, assign a score to each of the one or more secondary subchannels based on the subchannel energy, calculate a sum of the scores, and transmit a signal over the channel when the sum of the scores is less than a score threshold.

In addition to one or more of the features described herein, the processor is further configured to assign the score for a selected secondary subchannel based on an energy interval in which the energy of the secondary subchannel is located.

In addition to one or more of the features described herein, the processor is further configured to determine the channel to be idle when the energy of each of the one or more secondary subchannels is less than a secondary subchannel threshold.

In addition to one or more of the features described herein, the processor is further configured to transmit the signal with a selected probability, wherein the selected probability is a function of at least one of an access category, an age of a packet, and an urgency of the packet.

In addition to one or more of the features described herein, the processor is further configured to lower the score threshold when at least one of a physical layer protocol data unit (PPDU) is part of a high data rate frame and the PPDUs part of low latency flow.

In addition to one or more of the features described herein, the processor is further configured to assign a maximum score to the secondary subchannel when the energy in the secondary subchannel is from a Wi-Fi packet belonging to an Overlapping Basic Service Sets PPDU transmission.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a diagram illustrating various subchannels of a Wi-Fi channel, in an illustrative embodiment;

FIG. 3 is a diagram illustrating a method for determining a score for a secondary subchannel of the Wi-Fi channel; and

FIG. 4 is a flowchart of a method for identifying an occupancy of a channel of the communication system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

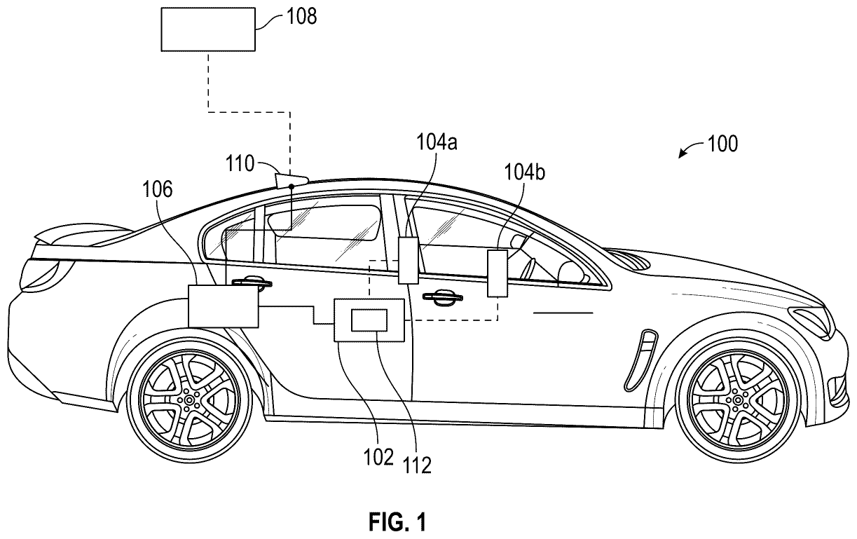

In accordance with an exemplary embodiment, FIG. 1 shows a vehicle 100. The vehicle 100 includes a WiFi communication device 102 that transmits and receives signals to communication devices 104a, 104b within the cabin of the vehicle 100 or outside but close to the vehicle. Two communication devices 104a, 104b are shown for illustrative purposes only. The communication devices 104a, 104b can include, for example, a portable phone, a portable laptop, a camera that communicates over a WiFi band, etc. An external communication system 106 communicates with the WiFi communication device 102 and controls the transmission between the WiFi communication device and a remote location 108 via an antenna 110.

The WiFi communication device 102 includes a controller 112 that controls operation of the WiFi communication device 102. The controller 112 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 112 may include a non-transitory computer-readable medium that stores instructions which, when processed by one or more processors of the controller 112, implement a method of determining whether a WiFi channel is busy, idle or semi-idle and transmitting a signal based on this state, according to one or more embodiments detailed herein.

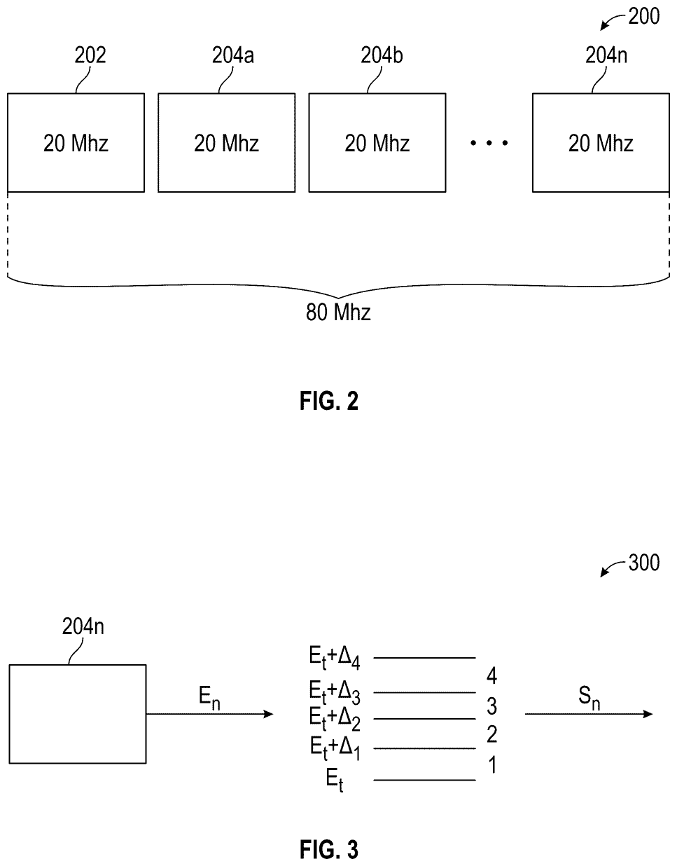

FIG. 2 shows a diagram 200 illustrating various subchannels of a Wi-Fi channel, in an illustrative embodiment. Current generations of WiFi operate within a frequency band, which can be centered at a carrier frequency such as 2.4 Gigahertz (GHz), 5 GHz and/or 6 Ghz. A channel within a frequency band includes a plurality of subchannels centered around the carrier frequency. The number of subchannels in a channel is dependent on the width of the frequency band. For illustrative purposes, an 80 MHz channel having four 20 Mhz subchannels is shown. The subchannels include a primary subchannel 202 and the three secondary subchannels 204a-204c. The primary subchannel 202 is generally used for 802.11 clients. The WiFi communication device 102 can include a means for measuring the amount of radio frequency (RF) energy in each of the primary subchannel 202 and the plurality of secondary subchannels 204a-204n. Such means can include, but is not limited to, a signal analyzer or signal analyzing program.

FIG. 3 is a diagram 300 illustrating a method for determining a score for a secondary subchannel. The score is related to a level of energy over the secondary subchannel and can be used to indicate how busy or occupied the channel is. An n^{th} secondary subchannel 204n is shown for illustrative purposes. A subchannel energy Eₙ is measured over the n^{th} subchannel. This energy in the subchannel is primarily due to current communications over the subchannel. Additionally, the energy in the subchannel can be a result of leakage from an adjacent subchannel(s) (referred to as out-of-band emissions) or from another communication device (e.g., Bluetooth, Ultra Wide Band device) operating within the same or adjacent frequency band as the subchannel. The subchannel energy Eₙ compared to a secondary channel threshold ED0. If the subchannel energy Eₙ is less than the secondary channel threshold ED0, then the secondary subchannel is considered to be idle. In terms of the score, an idle subchannel can be assigned a score of 0. The energy Eₙ is compared to a plurality of energy intervals and a score (Sₙ) is assigned to the subchannel based on the energy interval in which the subchannel energy Eₙ falls.

In FIG. 3, four energy intervals R1, R2, R3 and R4 are shown for illustrative purpose. The first energy interval R1 is between ED0 and ED0+Δ₁. The second energy interval R2 is between ED0+Δ₁ and ED0+Δ₂. The third energy interval R3 is between ED0+Δ₂ and ED0+Δ₃. The fourth energy interval R4 is between ED0+Δ₃ and ED0+Δ₄. In various embodiments, the values Δ1, Δ2, Δ3, Δ4 Δ1 are positive values increase in value with index. In an embodiment, the energy intervals are equal to each other. Thus, Δₙ₊₁-Δₙ₊₁ is a constant value. In an illustrative embodiment, an energy interval is 5 dBm.

For illustrative purposes, the score associated with energy interval R1 is 1, the score associated with energy interval R2 is 2, the score associated with energy interval R3 is 3, and the score associated with energy interval R4 is 4. In general, the score for energy interval Rₙ=n. The degree to which the subchannel is occupied is indicated by the score with the greater score indicating a mostly busy subchannel and the lower score indicating a mostly idle subchannel.

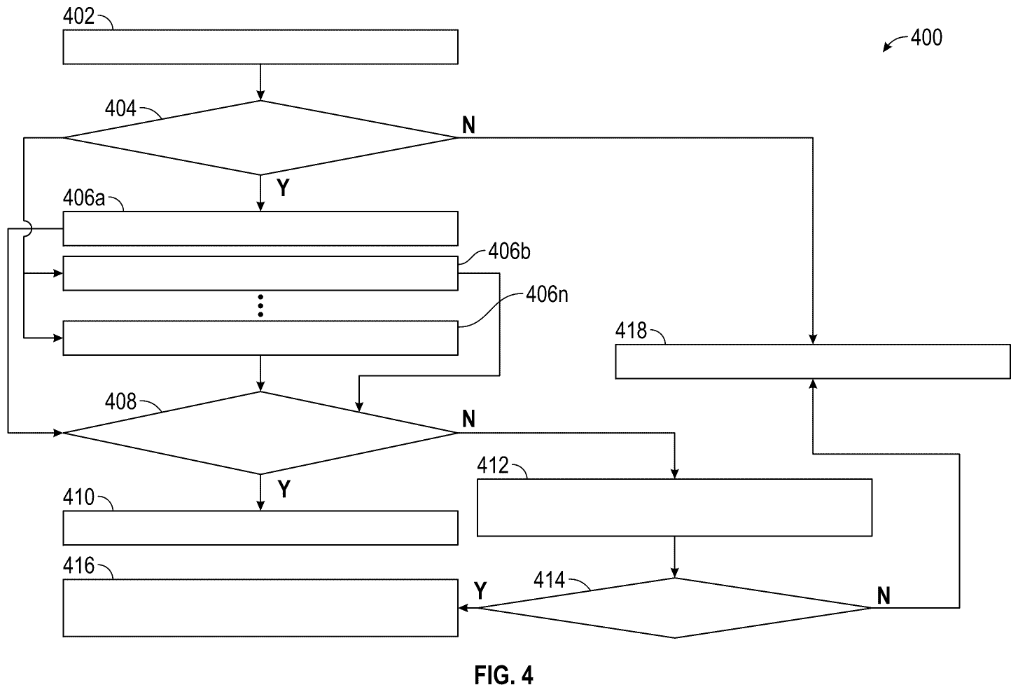

FIG. 4 is a flowchart 400 of a method for identifying an occupancy of a channel of the communication system. In box 402, a preamble detection is made on the primary channel. In box 404, the energy of the detection on the primary channel is compared to a primary channel energy threshold. If the energy is greater than or equal to the primary subchannel energy threshold EP0, the method proceeds to box 418. In box 418, the channel is declared to be busy. Returning to box 404, if the energy is less than the primary subchannel energy threshold EP0, the method proceeds to boxes 406a-406n.

Each of boxes 406a-406n includes performing a test of a corresponding secondary subchannel 204a-204n. The test includes applying a score to secondary subchannel 204a based on the energy of the second subchannel, as discussed with respect to FIG. 3. Once the tests are completed, the method proceeds to box 408.

In box 408, the scores of each of the secondary subchannels are reviewed. If the energy in each secondary subchannel is less than the secondary subchannel threshold (i.e., if En<ED0 for all n), the method proceeds to box 410. In box 410, the channel is determined to be idle.

Returning to box 408, if the energy in at least one of the secondary subchannels is greater than or equal to the secondary subchannel threshold (i.e., if at least one En>=ED0), then the method proceeds to box 412.

In box 412, the scores for each secondary subchannel are summed to calculate a total score. In box 414, the total score is compared to a score threshold. If the total score is equal to or greater than the score threshold, the method proceeds to box 418. In box 418, the channel is determined to be busy. Returning to 414, if the total score is less than the score threshold, the method proceeds to box 416.

In box 416, the channel is determined to be semi-idle. A signal can then be transmitted over the channel when the channel is semi-idle. The signal is transmitted with a probability P0. The probability P0 and/or the score threshold can be a function of an access category of the signal, an age of a packet of the signal, an urgency of the packet, or a combination thereof. An access category is one of Voice, Video, Best Effort, and Background.

If a packet has a high priority or is to be sent on a channel which is semi-idle, the level of encoding for packet can be increased in accordance with the level of priority.

The format of Wi-Fi data frames for transmission of data in an 802.11 network at the physical layer (PHY) is Physical Layer Convergence Procedure Protocol Data Unit (PPDU). A (PPDU) that includes a preamble and data fields. The preamble field contains the transmission vector format information. If QoS characteristics of the signal is known, various adjustments can be made to the parameters of the transmission. For PPDUs that are part of a high data rate signal, a lower sum score can be used when determining the channel to be semi-idle. In other words, the highest energy interval (e.g., ED0+Δn) can be lowered when scoring a subchannel when it is known that the PPDU is part of a high data rate signal.

For PPDUs that are part of a low latency signal, the PPDU can be transmitted even when the sum of score is high. Thus, the score threshold can be raised for signals that are part of a low latency signal.

When the energy detected on the subchannel is determined to be due to a Wi-Fi packet (PPDU) that is within a threshold that belongs to a transmission of an Overlapping Basic Service Sets (OBSS) PPDU, a score can be assigned to the subchannel to indicate that the subchannel is idle. If not, either a maximum score can be assigned to the subchannel or the entire channel can be designated as being busy.

In an embodiment, the score assigned to a subchannel can be based on a history of transmission on the subchannel. For example, if it is determined that the transmission is part of a periodic stream, a duty cycle of the stream can be measured and the score assigned to the subchannel can be a function of the duty cycle. The score can be directly proportional to the duty cycle. The duty cycle refers to a fraction of time within a time unit that is occupied by the signal. If the duty cycle indicates a transmission ending before the subchannel is being accessed, the subchannel can be used.

If the transmission is part of a periodic stream that is not a Wi-Fi transmission and a duty cycle of the transmission is low (i.e., such that the transmission completes before the Wi-Fi packet is transmitted) a low idle score can be assigned to the subchannel. The periodicity of the transmission can be based on a history of transmission over the subchannel and/or determined using machine learning.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of transmitting a signal in a wireless fidelity (WiFi) system, comprising:
determining that a primary subchannel of a channel of the WiFi system is idle when an energy in the primary subchannel is less than a primary subchannel energy threshold, wherein the channel includes the primary subchannel and one or more secondary subchannels;
measuring a subchannel energy through each of the one or more secondary subchannels;
assigning a score to each of the one or more secondary subchannels based on the subchannel energy;
calculating a sum of the scores; and
transmitting the signal over the channel when the sum of the scores is less than a score threshold.

2. The method of claim 1, further comprising assigning the score for a selected secondary subchannel based on an energy interval in which the energy of the secondary subchannel is located.

3. The method of claim 1, further comprising determining the channel to be idle when the energy of each of the one or more secondary subchannels is less than a secondary subchannel threshold.

4. The method of claim 1, further comprising transmitting the signal with a selected probability, wherein the selected probability is a function of at least one of: (i) an access category; (ii) an age of a packet; and (iii) an urgency of the packet.

5. The method of claim 1, further comprising lowering the score threshold when at least one of: (i) a physical layer protocol data unit (PPDU) is part of a high data rate frame; and (ii) the PPDUs part of low latency flow.

6. The method of claim 1, further comprising assigning a maximum score to the secondary subchannel when the energy in the secondary subchannel is from a Wi-Fi packet belonging to an Overlapping Basic Service Sets PPDU transmission.

7. The method of claim 1, wherein a history of transmission over the subchannel indicates a periodic stream and the score for the subchannel is determined at least in part based on a duty cycle of the periodic stream.

8. A wireless fidelity (WiFi) system, comprising:
a channel including a primary subchannel and one or more secondary subchannels;
a sensor for measuring an energy of signals in the primary subchannel and in each of the one or more secondary subchannels;
a processor configured to:
determine that the primary subchannel is idle when the energy in the primary subchannel is less than a primary subchannel energy threshold;
assign a score to each of the one or more secondary subchannels based on the subchannel energy;
calculate a sum of the scores; and
transmit a signal over the channel when the sum of the scores is less than a score threshold.

9. The WiFi system of claim 8, wherein the processor is further configured to assign the score for a selected secondary subchannel based on an energy interval in which the energy of the secondary subchannel is located.

10. The WiFi system of claim 8, wherein the processor is further configured to determine the channel to be idle when the energy of each of the one or more secondary subchannels is less than a secondary subchannel threshold.

11. The WiFi system of claim 8, wherein the processor is further configured to transmit the signal with a selected probability, wherein the selected probability is a function of at least one of: (i) an access category; (ii) an age of a packet; and (iii) an urgency of the packet.

12. The WiFi system of claim 8, wherein the processor is further configured to lower the score threshold when at least one of: (i) a physical layer protocol data unit (PPDU) is part of a high data rate frame; and (ii) the PPDUs part of low latency flow.

13. The WiFi system of claim 8, wherein the processor is further configured to assign a maximum score to the secondary subchannel when the energy in the secondary subchannel is from a Wi-Fi packet belonging to an Overlapping Basic Service Sets PPDU transmission.

14. The WiFi system of claim 8, wherein a history of transmission over the subchannel indicates a periodic stream and the score for the subchannel is determined at least in part based on a duty cycle of the periodic stream.

15. A vehicle, comprising:
a wireless fidelity (WiFi) system configured to communication over a channel including a primary subchannel and one or more secondary subchannels;
a sensor of the WiFi system configured to measure an energy of signals in the primary subchannel and in each of the one or more secondary subchannels;
a processor of the WiFi system, the processor configured to:
determine that the primary subchannel is idle when the energy in the primary subchannel is less than a primary subchannel energy threshold;
assign a score to each of the one or more secondary subchannels based on the subchannel energy;
calculate a sum of the scores; and
transmit a signal over the channel when the sum of the scores is less than a score threshold.

16. The vehicle of claim 15, wherein the processor is further configured to assign the score for a selected secondary subchannel based on an energy interval in which the energy of the secondary subchannel is located.

17. The vehicle of claim 15, wherein the processor is further configured to determine the channel to be idle when the energy of each of the one or more secondary subchannels is less than a secondary subchannel threshold.

18. The vehicle of claim 15, wherein the processor is further configured to transmit the signal with a selected probability, wherein the selected probability is a function of at least one of: (i) an access category; (ii) an age of a packet; and (iii) an urgency of the packet.

19. The vehicle of claim 15, wherein the processor is further configured to lower the score threshold when at least one of: (i) a physical layer protocol data unit (PPDU) is part of a high data rate frame; and (ii) the PPDUs part of low latency flow.

20. The vehicle of claim 15, wherein the processor is further configured to assign a maximum score to the secondary subchannel when the energy in the secondary subchannel is from a Wi-Fi packet belonging to an Overlapping Basic Service Sets PPDU transmission.
